(19) United States
(12) Patent Application Publication
(10) Pub. No.: US 2002/0020273 A1
(43) Pub. Date: Feb. 21, 2002

(54) CUTTER DEVICE AND PRINTER USING THIS

(76) Inventors: AKIO NOMURA, NAGANO (JP); KEIJI MURAKOSHI, NAGANO (JP)

Correspondence Address: NIXON & VANDERHYE, P.C.,, 1100 NORTH GLEBE ROAD, 8TH FLOOR, ARLINGTON, VA, 22201-4714, US

(21) Appl. No.: 09/403,565

(22) PCT Filed: Feb. 24, 1999
(86) PCT No.: PCT/JP99/00865

(30) Foreign Application Priority Data
Feb. 25, 1998 (JP) 10-43163

(51) Int. Cl. B26D 5/08

(52) U.S. Cl. 83/623

(57) ABSTRACT

The present invention relates to a printer such as an electronic cash register used for POS, particularly relates to a printer provided with a cutter for cutting recording paper in arbitrary length or cutting recording paper with a part left after cutting and the above printer is provided in that the dispersion of force required for tearing off recording paper is reduced, a torn trace of a left part after cutting of recording paper looks nice and in addition, the position of a left part after cutting of recording paper can be arbitrarily set respectively without increasing the size in the direction of the width of recording paper.

The cutter 4 according to the present invention is provided with

a fixed blade arranged in the vicinity of one side of a transport path for carrying recording paper, a first movable blade moved from a position where said first movable blade is opposed to said fixed blade with said transport path toward a direction approximately orthogonal to said transport path to slidably cross said fixed blade, a second movable blade arranged adjacent to said first movable blade at a predetermined position in a direction of the width of recording paper, which is moved from a position where said second movable blade is opposed to said fixed blade with said transport path toward a direction approximately orthogonal to said transport path to slidably cross said fixed blade, and a driving mechanism for moving said first movable blade (8) and said second movable blade.

### TECHNICAL FIELD

The present invention relates to a printer used for a point-of-sale (POS) for example such as an electronic cash register, particularly relates to a printer provided with a cutter device for cutting recording paper so that it has arbitrary length or cutting recording paper with a left part after cutting partly provided.

### BACKGROUND ART

Heretofore, for this type cutter device, a cutter device which is provided with a fixed blade and a movable blade installed with a transport path between them and which cuts recording paper by moving the movable blade and crossing it and the fixed blade is well-known.

For such a cutter device, a cutter device includes so that a movable blade formed by tilting its line to the tip by a predetermined angle with a direction in which the movable blade is moved is moved and recording paper is cut continuously from one side to the other side such as a cutter device disclosed in Japanese published unexamined patent application No. Hei4-365589 is known.

Also, for another example showing prior art, a cutter device includes so that a movable blade the line to the tip of which is notched is moved and recording paper is cut from both sides such as a cutter device disclosed in Japanese published unexamined patent application No Hei1-289697 and Japanese published examined patent application No. Hei8-22517 is known.

Further, a cutter device includes so that movable blades installed on the right and left sides of a transport path so that they can be turned are turned and recording paper is cut from both sides according to a clipping method such as a cutter device disclosed in Japanese published unexamined patent application No. Hei.5-104484 is known.

However, such conventional type cutter devices have the following problems.

That is, in the case of such types of cutters, it is required to prevent cut recording paper from being lost before an operator catches it that recording paper is partly left after cutting.

As for the cutter device disclosed in Japanese published unexamined patent application No. Hei4-365589, as a left part after cutting is on the side of recording paper and a transport path is formed so that the width is slightly wider than the width of recording paper , there is also a case that the left part after cutting is wide because the position of recording paper is biased right or left and it is difficult to fix the width of a left part after cutting.

If a left part after cutting is wide, there is a problem that recording paper on a transport path is pulled out when an operator tears off the left part after cutting of recording paper, a trace of the torn left part is diagonal and bad impression of it is made and conversely, if a left part after cutting is too narrow, there is a problem that the left part is torn off before an operator catches it.

In the meantime, the cutter device disclosed in Japanese published examined patent application No. Hei. 8-22517 does not have the above problems, however, as a left part after cutting is in the center of the width of recording paper, there is a problem that cut recording paper is tilted right or left, its posture is not stable and an operator is difficult to catch it. As the condition of right and left notched blades varies, a load applied to the movable blades becomes unbalanced, the movable blades are tilted, stable cutting is disabled and the quality of cutting may be deteriorated if a left part after cutting is shifted from the center of the width of recording paper to solve the above problem, a left part after cutting is limited to the center of the width of recording paper.

Also, as for the cutter device disclosed in Japanese published unexamined patent application No. Hei5-104484, as space is required on both right and left sides of a transport path to provide the rotating shaft of movable blades according to a clipping method on both sides of the transport path, there is a problem that the whole printer is large-sized in the direction of the width.

The present invention-is made to solve the above problems of prior art and the object is to provide a cutter device wherein recording paper can be torn with light stable force, a torn trace looks nice, in addition, the position of a left part after cutting of recording paper can be set to a position shifted from the center of the width and the size in the direction of the width of recording paper is miniaturized and a printer using the cutter device.

### DISCLOSURE OF THE INVENTION

A cutter device according to the present invention is characterized in that it is provided with a fixed blade arranged in the vicinity of one side of a transport path for carrying recording paper, a first movable blade moved from a position where said first movable blade is opposed to said fixed blade with said transport path toward a direction approximately orthogonal to said transport path to slidably cross said fixed blade, a second movable blade arranged adjacent to said first movable blade at a predetermined position in a direction of the width of recording paper, which is moved from a position where said second movable blade is opposed to said fixed blade with said transport path toward a direction approximately orthogonal to said transport path to slidably cross said fixed blade, and a driving mechanism for moving said first movable blade and said second movable blade.

According to the above configuration, as the first and second movable blades which is moved from a position where said first movable blade is opposed to said fixed blade with said transport path toward a direction approximately orthogonal to said transport path to slidably cross said fixed blade, a left part after cutting of recording paper can be set to a position other than the side of the recording paper, hereby, the dispersion of the width of the left part is reduced, pulling recording paper with stable force is enabled and it is enabled to make a torn trace look nice.

In addition, in the case of the present invention, as the first and second movable blades are separately included and the condition of cutting is independent, difference in the condition of cutting between both blades has no bad effect upon each even if a left part after cutting is shifted from the center of the width of recording paper.

Further, according to the present invention, as two movable blades approximately equal to the width of recording paper are included, a small-sized cutter can be provided.

Also, a cutter device according to the present invention is characterized in that it is provided with a fixed blade arranged in the vicinity of one side of a transport path for carrying recording paper, a first movable blade pivotally supported about pivot so that said first movable blade is moved from a position where said first movable blade is opposed to said fixed blade with said transport path toward a direction across said trasnport path to slidably cross said fixed blade, a second movable blade moved from a position said second movable blade is opposed to said fixed blade with said transport path toward a direction approximately orthogonal to said transport path to slidably cross said fixed blade and a driving mechanism for moving said first movable blade and said second movable blade.

According to the above configuration, as the so-called scissors-type movable blade is used for the first movable blade, driving force for moving the first movable blade can be reduced, particularly, if the first and second movable blades are included so that they are interlocked, the driving mechanism can be simplified and driving force for moving the whole movable blades can be reduced. Further, as only the first movable blade is made a scissors type, the size in the direction of the width of recording paper is not required to be increased and in addition, the cutter with the sharpness of the blades can be provided.

It is also effective that the present invention is included so that the first and second movable blades are interlocked by the link mechanism.

According to the above configuration, the first and second movable blades can be driven by one driving motor and the cutter with simple configuration can be acquired.

Also, it is also effective that the present invention is included so that engaging part are provided to the first and second movable blades and the first and second movable blades are interlocked by engaging the engaging portions.

According to the above configuration, as the link mechanism is not required, the cutter device with further simple configuration can be acquired.

Further, in the case of the present invention, as a fixed blade supporting mechanism by which the fixed blade can be separated from the first and second movable blades is provided, the setting of recording paper is facilitated and the removal of jammed paper in paper jam is also easy.

In the meantime, a printer using the cutter device according to the present invention is characterized in that the printer is provided with the body, a print head provided to the body for printing on recording paper and the cutter device according to any of claims 1 to 5.

According to the above configuration, the printer wherein the size in the direction of the width of recording paper is not required to be increased, force required for tearing off the recording paper hardly varies, a torn trace of a left part after cutting of the recording paper looks nice and in addition, the position of the left part of the recording paper can be arbitrarily set can be easily acquired.

### BRIEF DESCRIPTION OF THE DRAWINGS

FIG. 1 is a perspective view showing the appearance of a first embodiment of a printer according to the present invention,

FIGS. 2 are a plan and a front view showing the configuration of a cutter device in this embodiment and

FIGS. 3 are a plan and a front view showing the arrangement and the fitting of a fixed blade and a movable blade in this embodiment.

Also, FIG. 4 is a plan showing the configuration of a second embodiment of the present invention,

FIG. 5 are a front view showing the configuration of a cutter device in this embodiment and a sectional view showing a part in which a pressure shaft is mounted and

FIG. 6 is a side view showing the configuration of the cutter device in this embodiment.

Further, FIG. 7 is a plan showing the configuration of a third embodiment of the present invention.

Furthermore, FIG. 8 are a plan and a side view respectively showing the configuration of a fourth embodiment of the present invention.

### BEST EMBODIMENTS OF THE INVENTION

Referring to the drawings, embodiments of a cutter device according to the present invention and a printer using it will be described in detail below.

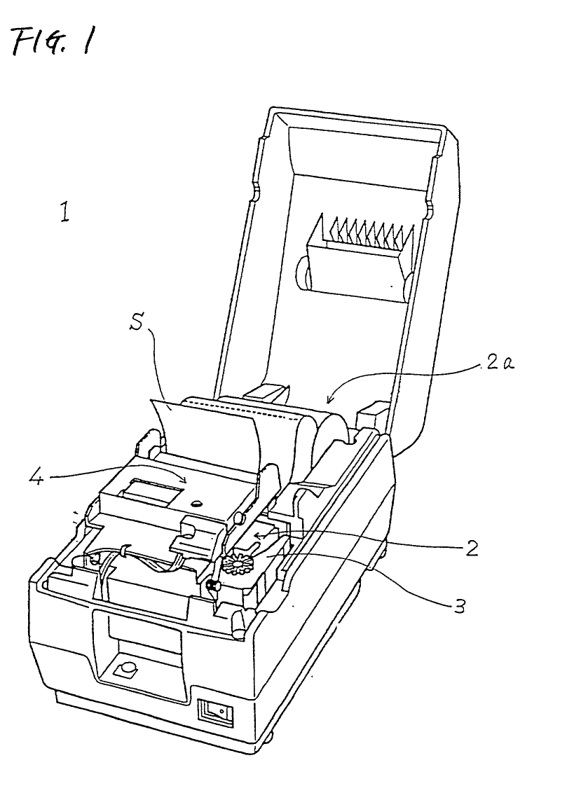

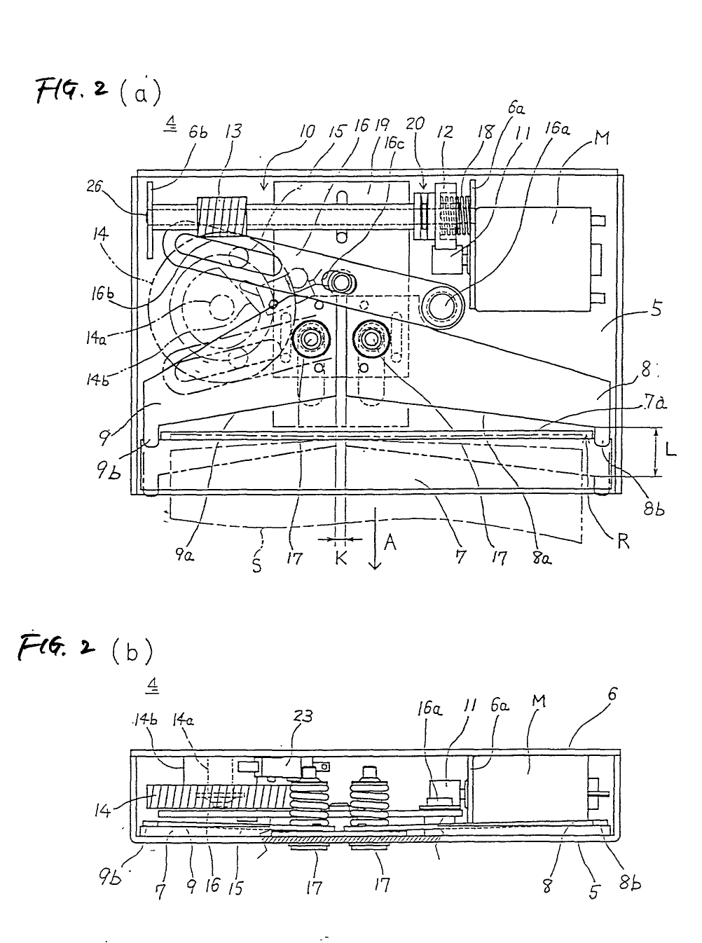

FIG. 1 is a perspective view showing the appearance of a printer equivalent to an embodiment.

As shown in FIG. 1, a printer 1 equivalent to this embodiment is a dot impact printer applied to an electronic cash register used for POS and others and include the body 2 of the printer from which a ribbon cassette 3 can be detached and the housing 2a of recording paper S provided at the back of the body 2.

A print head not shown for executing predetermined printing on recording paper S, a paper feeding mechanism not shown for feeding the recording paper S to a printing position and a cutter device 4 for cutting the printed recording paper S are provided to the body 2.

As shown in FIG. 1, the cutter device 4 is provided above the body 2 and includes as follows.

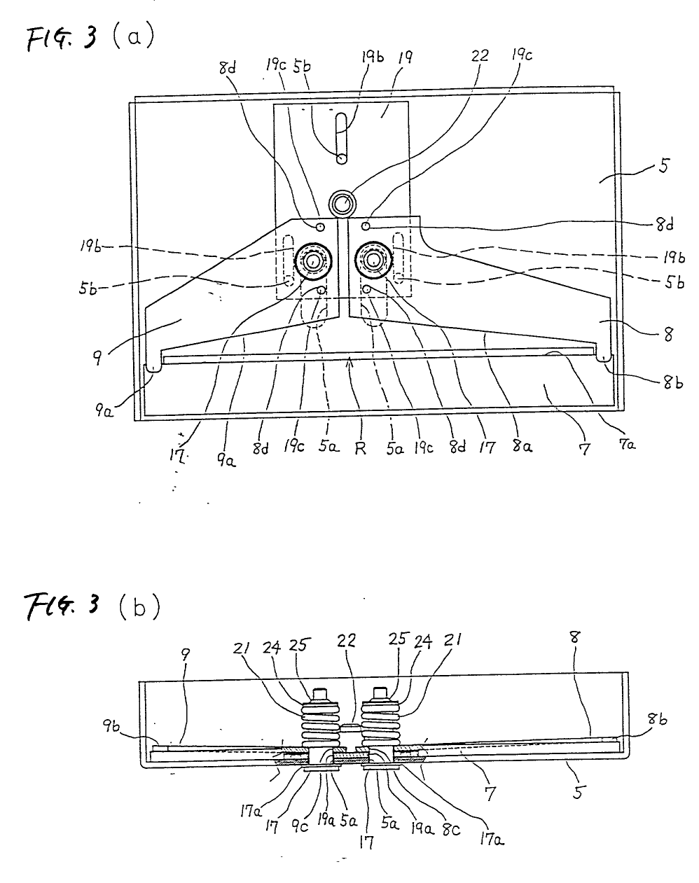

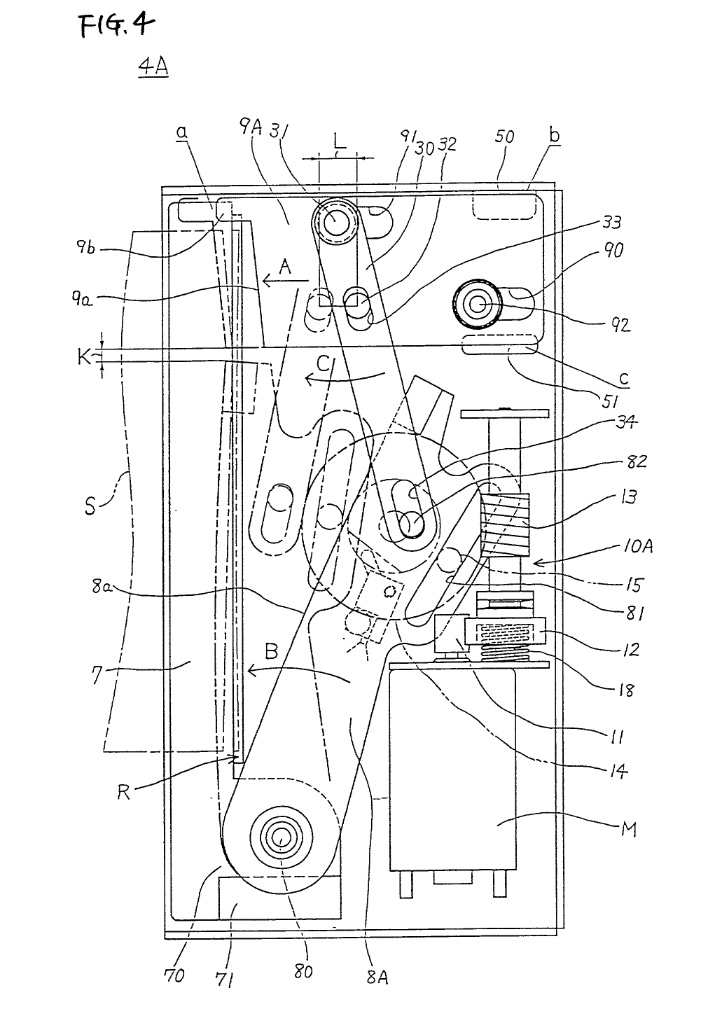

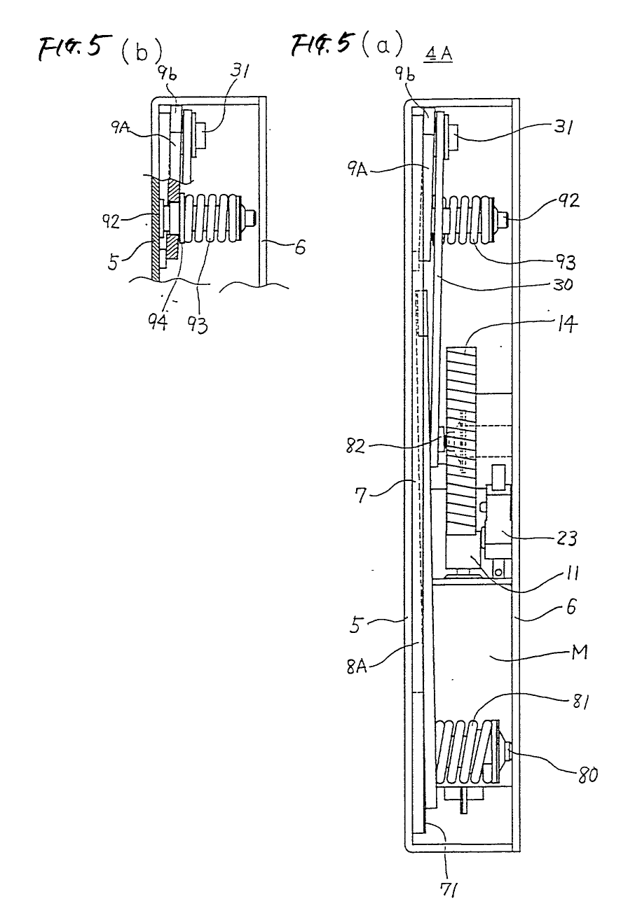

FIG. 2(a) is a plan showing the configuration of the first embodiment of the cutter device according to the present invention and a cutter device cover 6 covering the upper surface is not shown to show the internal structure. FIG. 2(b) is a front view showing the configuration of the cutter device. FIG. 3(a) is a plan showing the arrangement and the fitting of a fixed blade and a movable blade in this embodiment and FIG. 3(b) is its front view.

As shown in FIGS. 2(a) and 2(b), the cutter device 4 in this embodiment is provided with a housing including a cutter frame 5 and a cutter cover 6.

The cutter frame 5 includes a box-type member made by bending a metallic plate such as a plated steel plate and as shown in FIG. 3, the fixed blade 7 made of stainless steel is fixed to one side with a longer edge. In this embodiment, the fixed blade 7 includes a long member.

On the opposite side to the fixed blade 7 with the transport path R of recording paper S between them, a first movable blade 8 and a second movable blade 9 respectively made of stainless steel and formed substantially in the shape of a triangle are provided. In this embodiment, as a left part after cutting is set off from the center of the width of recording paper, the first movable blade 8 is formed so that it is larger than the second movable blade 9.

At each end of the first and second movable blades 8 and 9 off the transport path R, movement guiding parts 8b and 9b protruded on the side of the fixed blade 7 are formed and these movement guiding parts 8b and 9b are constituted so that the movable blades 8 and 9 are also above the fixed blade 7 on standby. Each line to the tip of the cutting parts 8a and 9a of the first and second movable blades 8 and 9 is tilted by a predetermined angle with a line to the tip of the cutting part 7a of the fixed blade 7 so that an interval between the cutting part 7a of the fixed blade 7 and the cutting part 8a or 9a of the first or second movable blade 8 or 9 becomes longer toward the center from both ends of the fixed blade 7.

As shown in FIG. 2(a), the first movable blade 8 and the second movable blade 9 are arranged apart by predetermined distance K in the vicinity of the center of the fixed blade 7. By such constitution, each line to the tip of the cutting parts 8a and 9a of the first and second movable blades 8 and 9 is formed so that the above each line and a line to the tip of the cutting part 7a of the fixed blade 7 form substantially V shape.

In this embodiment, the first and second movable blades 8 and 9 are driven by a driving mechanism 10 having the following structure. That is, as shown in FIG. 2(a), the above driving mechanism includes a driving motor M, a motor gear 11 for transmitting the torque of the driving motor M to the first and second movable blades 8 and 9, a reduction gear 12, a worm 13 and a driving gear 14. In this embodiment, the driving mechanism 10 is attached to the cutter cover 6.

The driving motor M is fixed to a mounting plate 6a bent from the cutter cover 6 with screws and others. The reduction gear 12 and the worm 13 are supported by a metallic reduction shaft 26 put between the mounting plates 6a and 6b and fixed to them so that the reduction gear and the worm can be rotated. A clutch 20 is formed on the respective opposite end faces of the worm 13 and the reduction gear 12. In detail, the clutch 20 includes mutually engaged ratchets formed in the rotational direction of the respective end faces respectively opposite to the worm 13 and the reduction gear 12 though the ratchets are not shown in the drawing and a clutch spring 18 for pressing the reduction gear 12 which can be moved on the reduction shaft 26 in the axial direction on the worm 13.

The disc-like driving gear 14 engaged with the worm 13 is mounted around a spindle 14a fixed to the cutter cover 6 so that the driving gear can be turned and a driving pin 15 is provided to the upper surface of the driving gear 14. A long metallic link lever 16 is attached to the cutter frame 5 via a spindle 16a so that the link lever can be turned, a long hole 16b formed at the end of the link lever 16 and the driving pin 15 of the driving gear 14 are fitted and the link lever 16 is constituted so that it is turned as the driving gear 14 is turned.

Further, a long hole 16c formed in the middle of the link lever 16 and a slide driving pin 22 provided to a slide plate 19 described later are fitted so that the slide plate 19 is reciprocated as the link lever 16 is turned.

As shown in FIG. 3(a), the slide plate 19 includes a square metallic member and in the center, the above slide driving pin 22 is provided. Three long holes 19b extended in the longitudinal direction and four projections 19c protruded on the upper side are also provided to the slide plate 19. The long hole 19b of the slide plate 19 is formed so that it is fitted to a projection 5b protruded on the upper side from the cutter frame 5 and the projections 19c of the slide plate 19 are formed so that they are respectively fitted into holes 8d and 9d provided to the first and second movable blades 8 and 9.

A pressure shaft 17 is provided to the vicinity of the center of fittings mounted with them overlapped with the first or second movable blade 8 or 9. As shown in FIG. 3(b), the pressure shaft 17 pierces a long hole 5a of the cutter frame 5, the hole 19a of the slide plate 19 and a hole 8c or 9c of the first or second movable blade 8 or 9 via a washer 17a.

The first and second movable blades 8 and 9 press the cutter frame 5, the movement guiding parts 8b and 9b and the cutting parts 8a and 9a of the first and second movable blades 8 and 9 on the fixed blade 7 via the slide plate 19 by stopping a helical compression spring 21 wound on the pressure shaft 17 with a retaining ring 25 via a washer 24.

The strength of the helical compression spring 21 is set according to the degree of the respective inclination, the shear angle and others of the first and second movable blades 8 and 9.

As shown in FIG. 3(b), the slide plate 19 is formed so that it is thinner than the thickness of the fixed blade 7 and hereby, a suitable tilt angle is applied to the first and second movable blades 8 and 9.

As shown in FIG. 2(b), a detector 23 is attached to the cutter cover 6 above the driving gear 14 and the waiting position of the first and second movable blades 8 and 9 is detected depending upon whether the detector 23 is in contact with a cam 14b provided to the driving gear 14 or not.

In this embodiment provided with such configuration, when the driving motor M is driven, its torque is transmitted to the driving gear 14 via the motor gear 11, the reduction gear 12 and the worm 13, the driving gear 14 is rotated and as a result, the link lever 16 is moved from a position shown by a full line in FIG. 2(a) to a position shown by an alternate long and two short dashes line. In this case, as the long hole 19b of the slide plate 19 is guided in a direction shown by an arrow A by the projection 5b of the cutter frame 5, the first and second movable blades 8 and 9 fitted to the slide plate 19 are also moved in the direction shown by the arrow A and when the cutting parts 8a and 9a of the first and second movable blades 8 and 9 are slid on the cutting part a of the fixed blade 7 by distance L, recording paper S is cut.

When a foreign matter and others are put between the first or second movable blades 8 or 9 and the fixed blade 7 and they are locked during cutting, the members composing the cutter device are protected because a slide occurs in the clutch between the reduction gear 12 and the worm 13.

As described above, according to this embodiment, as a left part after cutting of recording paper S can be set so that it is in a position other than the side of the recording paper S and in addition, it is fixed because the first and second movable blades 8 and 9 which can cross the fixed blade 7 and can be slid on the fixed blade 7 are provided, the length of the left part after cutting is fixed even if the recording paper S is cut with it biased on either side of the right or the left in a transport path and the impression of a cut part can be enhanced without increasing force for pulling paper when the recording paper is cut.

In addition, in this embodiment, as the first and second movable blades 8 and 9 are separately included, the condition of cutting of the movable blade and the fixed blade is unchanged even if loads onto the respective blades are different if the left part after cutting is off the central part of the width of recording paper S, a problem such as a failure of cutting that recording paper is drawn between the movable blade and the fixed blade because the pressure of one movable blade is reduced by unbalance such as occurs in prior art does not occur and the quality of cutting is not deteriorated.

Further, according to this embodiment, as the first and second movable blades 8 and 9 comply with a sliding method, the movement of the movable blade can be limited to a range approximately equal to the width of recording paper S and a small-sized cutter device can be provided.

In addition, according to this embodiment, as the link lever 16 composing a link mechanism is fitted to the first and second movable blades 8 and 9, a cutter device the configuration of which is simple can be acquired.

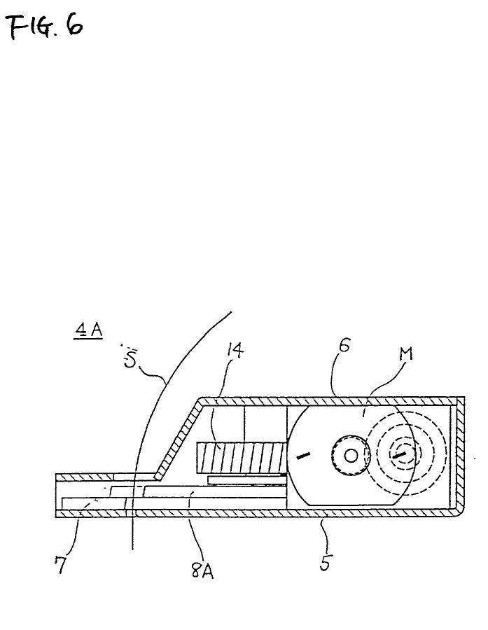

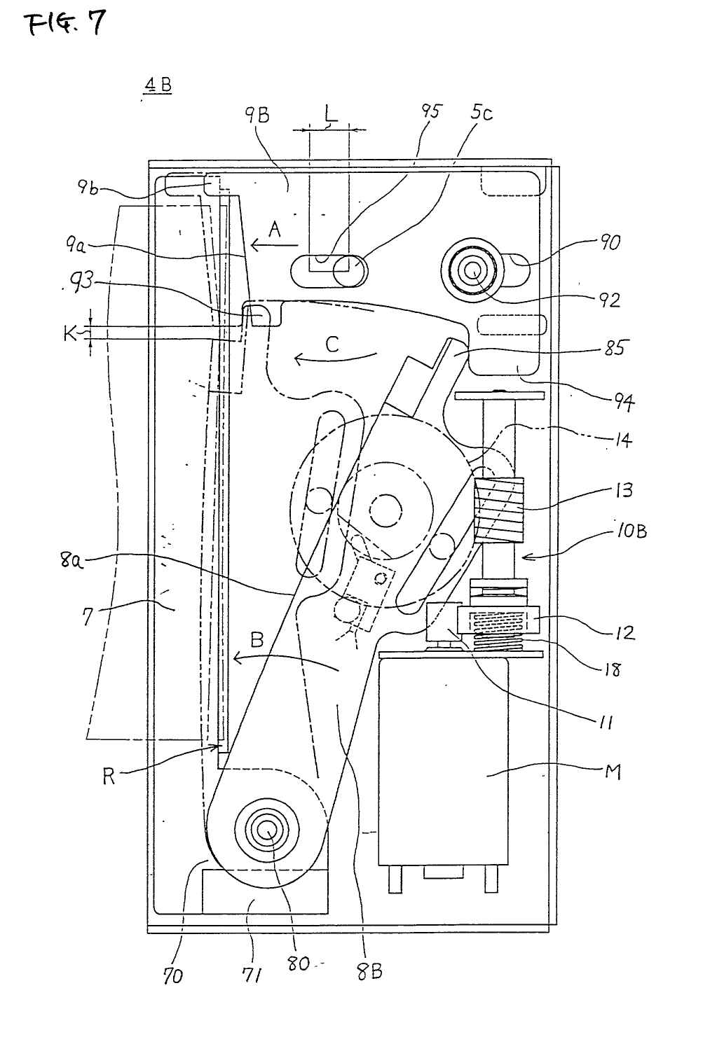

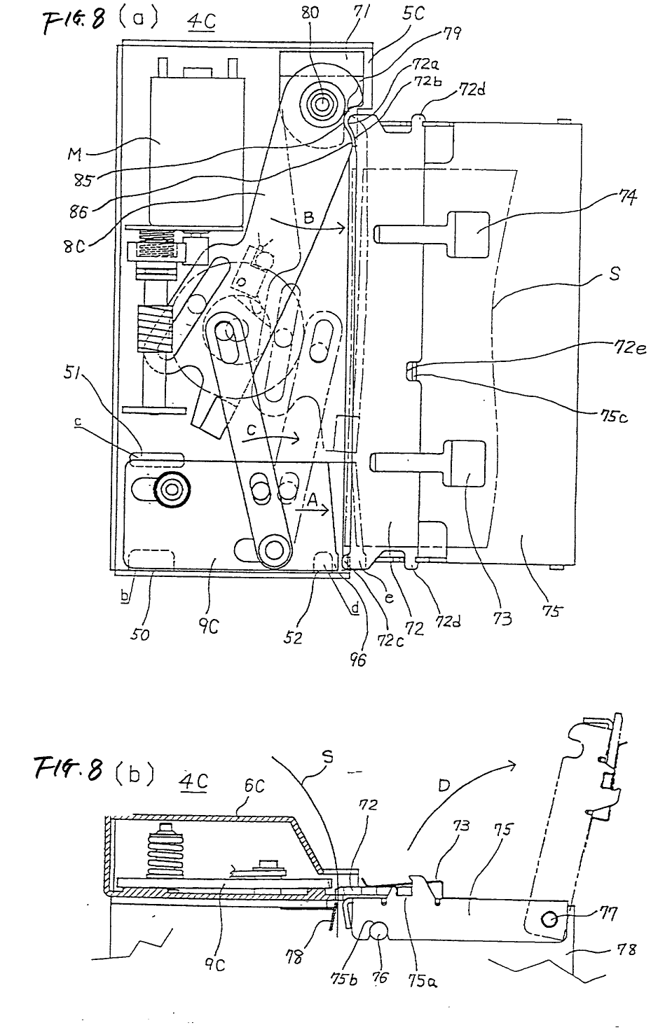

FIG. 4 is a plan showing the configuration of a second embodiment of the cutter device according to the present invention and a cutter cover 6 covering the upper surface is not shown to show the internal structure. FIG. 5(a) is a front view showing the configuration of the above cutter device, FIG. 5(b) is a sectional view showing the fittings of the pressure shaft of the cutter device and FIG. 6 is a side view showing the configuration of the cutter device. A part common to that in the above embodiment will be described below using the same reference number as in the above embodiment.

A cutter device 4A equivalent to this embodiment is characterized in that a so-called scissors-type first movable blade 8A is used in a driving mechanism 10A. As shown in FIG. 4, in this embodiment, a fixed blade 7 is provided to one edge of a cutter frame 5 and the first movable blade 8A having predetermined length is provided to the base -70 of the fixed blade 7 so that the first movable blade can be turned with a pivot 80 in the center.

As shown in FIG. 5(a), a helical compression spring 81 for pressing the first movable blade 8A on the fixed blade 7 is wound on the pivot 80. A spacer 71 between the fixed blade 7 and the first movable blade 8A is fixed to the base 70 of the fixed blade 7 on the side of the pivot 80 reverse to the cutting part 8a of the first movable blade 8A to tilt the first movable blade 8A to the fixed blade 7. As shown in FIG. 4, a long hole 81 fitted to a driving pin 15 of a driving gear 14 and a driving pin 82 protruded upward in the vicinity are provided to the first movable blade 8A.

In the meantime, a second movable blade 9A in this embodiment includes a substantially square member, and a cutting part 9a and a movement guiding part 9b respectively similar to those in the above embodiment are formed. As for the second movable blade 9A, a long hole 91 extended in a direction shown by an arrow A is formed in the vicinity of the front end and a long hole 90 extended in the direction shown by the arrow A is formed in the vicinity of the rear end reverse to the long hole 91. Further, a driving pin 32 protruded upward is provided.

As shown in FIG. 5(b), a pressure shaft 92 which pierces the above long hole 90 and on which a helical compression spring 93 for pressing the second movable blade 9A on the fixed blade 7 and supporting sections 50 and 51 described later is wound via a pressure washer 94 is attached to the cutter frame 5.

As shown in FIG. 4, the second movable blade 9A is arranged so that its movement guiding part 9b is on the fixed blade 7 and is supported by the supporting sections 50 and 51 provided to the cutter frame 5. In this case, if the thickness of the fixed blade 7 is a, the thickness of the supporting section 50 is b and the thickness of the supporting section 51 is c, it is desirable that relationship among them is set to “a>b>c”. That is, by composing as described above, a line to the tip of the cutting part 9a of the second movable blade 9A is tilted toward the fixed blade 7, the condition of crossing and sliding required for cutting recording paper S is secured and the stable cutting of the recording paper S is enabled.

Also, the long hole 91 extended in the direction shown by the arrow A is formed at one edge of the second movable blade 9A and a spindle 31 which pierces the long hole 91 is provided to a part of the cutter frame 5 corresponding to the long hole 91. A long link lever 30 is provided to the spindle 31 so that the link lever can be turned. A long hole 33 is provided to the central side of the link lever 30 and the long hole 33 is fitted to a driving pin 32 of the second movable blade 9A.

Further, a long hole 34 is provided to the end of the link lever 30 and a link mechanism is defined by fitting the driving pin 82 of the first movable blade 8A and the long hole 34 of the link lever 30.

In this embodiment included as described above, when the driving motor M is driven, its torque is transmitted to the driving gear 14 via the motor gear 11, the reduction gear 12 and the worm 13, the driving gear 14 is rotated and hereby, the first movable blade 8A is rotated in a direction shown by an arrow B. Simultaneously, the link lever 30 is rotated in a direction shown by an arrow C and hereby, the second movable blade 9A is moved by distance L in the direction shown by the arrow A. As a result, the first and second movable blades 8A and 9A are moved from a position shown by a full line in FIG. 4 to a position shown by an alternate long and two short dashes line and recording paper S is cut. In this case, the cutting part 8a of the first movable blade BA and the cutting part 9a of the second movable blade 9A are included so that they are separated by predetermined distance (width left after cutting) K in a part in which they are adjacent and hereby, recording paper S is cut with the recording paper left by predetermined width left after cutting K.

As described above, according to this embodiment, as the so-called scissors-type first movable blade 8A is used in addition to it that a left part after cutting of recording paper S can be set to a position other than the side of the recording paper S as in the above embodiment, driving force for moving the first and second movable blades 8A and 9A can be reduced. Further, as only the first movable blade is made a scissors type, the size in the direction of the width of recording paper S is not required to be increased and in addition, the cutter device with the sharpness of the blades can be provided.

As the other configuration, action and effect are the same as those in the above embodiment, the description is omitted.

FIG. 7 is a plan showing the configuration of a third embodiment of the cutter device according to the present invention.

This embodiment includes so that a second movable blade 9B is moved without using a link lever in a driving mechanism 10B and the same reference number is allocated to a part common to the part in the above embodiment.

As shown in FIG. 7, in this embodiment, an engaging portion 85 is formed at the end of a first movable blade 8B and two engaging portions 93 and 94 for engaging with the engaging portion 85 of the first movable blade 8B are formed in the second movable blade 9B. The engaging portions 93 and 94 of the second movable blade 9B are formed at a predetermined interval and the engaging portion 85 comes in contact with the engaging portions 93 and 94 of the second movable blade 9B by turning the first movable blade 8B.

Also, in this embodiment, a guide pin 5c is provided to a cutter frame 5 and the guide pin 5c is fitted into a guide hole 95 extended in a direction shown by an arrow A and formed on the second movable blade 9B.

In this embodiment provided with the above configuration, when a driving motor M is driven, its torque is transmitted to a driving gear 14 via a motor gear 11, a reduction gear 12 and a worm 13, the driving gear 14 is rotated and hereby, the first movable blade 8B is rotated in a direction shown by an arrow B. As a result, a part on one side of recording paper S is cut by the cutting part 8a of the first movable blade 8B, the second movable blade 9B is moved in the direction shown by the arrow A by engaging the engaging portion 85 of the first movable blade 8B to the engaging portions 93 of the second movable blade 9B, a part on the other side of the recording paper S is cut and hereby, the recording paper S is cut with only predetermined left width after cutting K left.

As described above, according to this embodiment, as no link lever is used in addition to it that a left part after cutting of recording paper S can be set to a position other than the side of the recording paper S, the configuration can be further simplified. As the other configuration, action and effect are the same as those in the above embodiments, the detailed description is omitted.

FIGS. 8 show the configuration of a fourth embodiment of the cutter device according to the present invention, FIG. 8(a) is a plan showing the cutter device according to the present invention, a cutter cover 6C covering the upper surface is not shown to show the internal structure and FIG. 8(b) is a front view showing the configuration of the cutter device. In this embodiment, a fixed blade 72 is included so that it can be moved from a cutting position opposite to movable blades 8c and 9c to a position in which the fixed blade is separated from the movable blades and the same reference number is allocated to a part common to that in the above embodiments.

As shown in FIG. 8(b), the fixed blade 72 is attached to a fixed blade frame 75 supported by the spindle 77 of a base 78 so that the fixed blade can be turned. In the meantime, a first movable blade 8C is attached to a pivot 80 via a movable blade supporting part 79 having the same thickness as the fixed blade 72. A spacer 71 is fixed to the movable blade supporting part 79 to tilt the first movable blade 8C toward the fixed blade 72.

As shown in FIG. 8(a), the first movable blade 8C is provided with a twisted part 85 in the vicinity of the pivot 80, while the fixed blade 72 is provided with a convex portion 72a opposite to the twisted part 85 near the twisted part when the fixed blade 72 is located in a cutting position. Hereby, when the first movable blade 8C is turned in a direction shown by an arrow B, a clipping type cutting condition is secured by locating a convex portion 86 of the first movable blade 8C on a concave portion 72b of the fixed blade 72.

In the meantime, a second movable blade 9C is provided with a convex portion 96 outside a transport path and the fixed blade 72 is provided with a convex portion 72c having a slope for guiding the second movable blade 9C upward in a position opposite to the convex portion 96. Hereby, when the second movable blade 9C is moved in a direction shown by an arrow A, a slide-type cutting condition is secured by locating the convex portion 96 on the convex portion 72c.

The second movable blade is supported by supporting sections 50, 51 and 52 provided to a cutter frame 5C and if the thickness of the respective supporting sections is b, c and d and the thickness of the fixed blade 72 is e, it is desirable that relationship among them is set to “e>d>c”.

A convex portion 72d and a concave portion 72e are provided to the fixed blade 72, the convex portion 72d of the fixed blade is fitted into a fixed blade supporting part 75a provided to a fixed blade frame 75 so that the convex portion 72d can be swung and the concave portion 72e of the fixed blade 72 is fitted to a projection 75c provided to the fixed blade frame 75 to decide the right and left positions of the fixed blade 72. The fixed blade 72 is pressed on the fixed blade frame 75 by plate springs 73 and 74 provided to the cutter frame 5C.

As shown in FIG. 8(b), as to the fixed blade frame 75, a position when recording paper is cut is decided by pressing a notch 75b on a stopper shaft 76 provided to the base 78.

In this embodiment included as described above, when recording paper S is set in a printer, the fixed blade frame 75 is turned in a direction shown by an arrow D and the fixed blade 72 is separated from the first and second movable blades 8C and 9C. Next, rolled paper for example is housed in a housing not shown via an opening and the setting of recording paper is completed by turning the fixed blade frame 75 in a direction reverse to the direction shown by the arrow D with the upper end of recording paper S pulled out upward from a cover frame 6C until the fixed blade frame is touched to the stopper shaft 76.

As described above, according to the present invention, as paper is not required to pass narrow clearance between the first or second movable blade 8C or 9C and the fixed blade 72 when recording paper S is set, the design of a transport path of recording paper S is facilitated, paper jam is not required to be worried and the setting of recording paper is also simplified. Further, even if paper jam occurs, the fixed blade frame 75 is turned in the direction shown by the arrow D and jammed paper can be easily removed.

The present invention is not limited to the above embodiments and can be variously varied.

For example, in the first embodiment, the first and second movable blades are different in size, however, the present invention is not limited to this and the first and second movable blades can be also included so that the length of each cutting part of the first and second movable blades is equal and a central part in the width of paper is left after cutting. In the above embodiment, for a cutting method, a sliding type is adopted, however, one movable blade may be also formed so that it is another type such as Guillotine cutter device with sawteeth. Also, the fixed blade is shared by the first and second movable blades, however, the fixed blade can be also individually provided to each movable blade.

Further, in the above embodiments, the example of the cutter device for cutting one recording paper is described, however, the present invention is not limited to this and can be also applied to a cutter device for cutting parallel two recording paper. However, the present invention is most effective in case the present invention is applied to a cutter device for cutting one recording paper with a part left after cutting as in the above embodiments.

Furthermore, the present invention can be applied to not only a dot impact printer but various printers such as a thermal printer and an ink-jet printer.

Industrial Availability

As described above, the cutter device according to the present invention and the printer using it is useful for a printer such as an electronic cash register used in POS and particularly, is suitable to use for a cutter device for cutting recording paper in arbitrary length or cutting it with a part left after cutting.

What is claimed is:

1. A cutter device comprising:
a fixed blade (7, 72) arranged in the vicinity of one side of a transport path (R) for carrying recording paper (S);
a first movable blade (8, 8A, 8B, 8C) moved from a position where said first movable blade (8, 8A, 8B, 8C)is opposed to said fixed blade (7,72) with said transport path (R) toward a direction approximately orthogonal to said transport path (R) to slidably cross said fixed blade (7, 72);
a second movable blade (9, 9A, 9B, 9C) arranged adjacent to said first movable blade (8, 8A, 8B, 8C) at a predetermined position in a direction of the width of recording paper (S), which is moved from a position where said second movable blade (9, 9A, 9B, 9C) is opposed to said fixed blade (7, 72) with said transport path (R) toward a direction approximately orthogonal to said transport path (R) to slidably cross said fixed blade (7, 72); and
a driving mechanism (10) for moving said first movable blade (8) and said second movable blade (9, 9A, 9B, 9C).

2. A cutter device, comprising:
a fixed blade (7, 72) arranged in the vicinity of one side of a transport path (R) for carrying recording paper(S);
a first movable blade (8A, 8B, 8C) pivotally supported about pivot (80) so that said first movable blade is moved from a position where said first movable blade (8, 8A, 8B, 8C) is opposed to said fixed blade (7, 72) with said transport path (R) toward a direction across said trasnport path (R) to slidably cross said fixed blade (7, 72);
a second movable blade (9A, 9B, 9C) moved from a position where said second movable blade (9, 9A, 9B, 9C) is opposed to said fixed blade (7, 72) with said transport path (R) toward a direction approximately orthogonal to said transport path (R) to slidably cross said fixed blade (7, 72) and
a driving mechanism (10A) for moving said first movable blade (8A, 8B, 8C) and said second movable blade (9A, 9B, 9C).

3. A cutter device according to either of claim 1 or 2, wherein said first movable blade (8, 8A, 8B, 8C) and said second movable blade (9, 9A, 9B, 9C) are interlocked by a link mechanism.

4. A cutter device according to either of claim 1 or 2, wherein engaging portions (85, 93, 94)are provided on said first movable blade (8B) and said second movable blade (9B),respectively; and said first movable blade (8B) and said second movable blade (9B) are interlocked by engaging with engaging portions(85, 93, 94).

5. A cutter device according to any of claims 1 to 4, wherein said fixed blade (72) is provided with a fixed blade supporting mechanism which can separate said fixed blade from said first movable blade (8C) and said second movable blade (9C).

6. A printer provided with a cutter device (4) according to any of claims 1 to 5, comprising:
the body (2); and
a print head provided to said body (2) for printing on recording paper (S).
